(19) United States
(12) Patent Application Publication
(10) Pub. No.: US 2018/0137124 A1
(43) Pub. Date: May 17, 2018

(54) TRANSLATION OF A SEARCH QUERY INTO SEARCH OPERATORS

(71) Applicant: Twiggle Ltd., Tel-Aviv (IL)

(72) Inventors: Amir KONIGSBERG, Tel-Aviv (IL); Adi AVIDOR, Tel-Aviv (IL)

(21) Appl. No.: 15/351,640

(22) Filed: Nov. 15, 2016

(51) Int. Cl. G06F 17/30; G06F 3/0482

(52) U.S. Cl. CPC G06F 17/3043; G06F 17/30321; G06F 3/0482; G06F 17/30867; G06F 17/30554

(57) ABSTRACT

A system and method for translating a search query to search operators usable by a search server to extract search results from a database, the method comprising identifying in a database model an attribute related to a database category that corresponds to a search term received via a search user interface, the database model includes a value space of possible values of the identified attribute translating the search term to a search operator by analyzing distribution of values in the value space of the identified attribute and determining based on the analyzed distribution whether to translate the search term to filtering or sorting search operator, and extracting search results by applying the determined search operator on a database indexed according to the database model.

### FIELD AND BACKGROUND OF THE INVENTION

The present invention, in some embodiments thereof, relates to database search methods and, more specifically, but not exclusively, to database search by interpretation of meaning of search terms.

In many search engines, search is performed by looking for the search terms or synonymous terms in text and/or metadata of database items. Sorting and ranking of results may be performed according to predefined parameters or preferences selected by the user, usually separately from the query terms input.

### SUMMARY OF THE INVENTION

According to an aspect of some embodiments of the present invention there is provided a system for translating a search query to search operators usable by a search server to extract search results from a database, the system including: a memory storing a code; and at least one hardware processor coupled to the memory for executing the code, the code including: instructions for identifying in a database model an attribute related to a database category that corresponds to a search term received via a search user interface, the database model includes a value space of possible values of the identified attribute; instructions for translating the search term to a search operator by analyzing distribution of values in the value space of the identified attribute and determining based on the analyzed distribution the whether to translate the search term to filtering or sorting search operator; and instructions for extracting search results by applying the determined search operator on a database indexed according to the database model.

Optionally, the code includes instructions for creating the indexed database by indexing data included in a target data source according to the database model, wherein each item in the indexed database belongs to a database category and has at least one related attribute value.

Optionally, identifying a corresponding attribute is performed by identifying literal similarity between the search term and the name of the attribute.

Optionally, identifying a corresponding attribute is performed according to a rule embedded in the database model that relates a term to a certain attribute.

Optionally, the code includes instructions for determining if the type of operator is a sorting operator or filtering operator.

Optionally, the type of operator is determined according to identification of the attribute as a Boolean or multi-value attribute.

Optionally, the code includes instructions for translating a query term to a threshold operator for filtering search results that cross a threshold determined by interpreting the term as a threshold according to the database model.

Optionally, the code includes instructions for translating a query term to a sorting operator and for determining a direction of the sorting by interpreting a term as a ranking parameter according to the database model.

According to an aspect of some embodiments of the present invention there is provided a system for controlling a graphical user interface (GUI) to display search results according to search operators applied by a search server on a database, the system including: a memory storing a code; and at least one hardware processor coupled to the memory for executing the code, the code including: instructions for translating a search term received via a GUI to a search operator by: identifying in an e-commerce database model an attribute related to an e-commerce category that correspond to the received search term, the database model includes a value space of possible values of the identified attribute; and determining based on distribution of values in the value space the suitable type of search operator for translation of the search term; instructions for extracting search results by applying the determined search operator on a database indexed according to the database model; and instructions for updating the GUI to display the search results along with indication of applied operators.

Optionally, updating the GUI includes updating at least one of presented search results, an order of the search results and query-related information presented in the vicinity of the search results.

Optionally, the code includes instructions for extracting along with the search results query-specific information about the search results according to interpretation of the query terms by the database model, and for updating the GUI to display query-related information in the vicinity of the search results.

According to an aspect of some embodiments of the present invention there is provided a method for translating a search query to search operators usable by a search server to extract search results from a database, the method including: identifying in a database model an attribute related to a database category that corresponds to a search term received via a search user interface, the database model includes a value space of possible values of the identified attribute; translating the search term to a search operator by analyzing distribution of values in the value space of the identified attribute and determining based on the analyzed distribution whether to translate the search term to filtering or sorting search operator; and extracting search results by applying the determined search operator on a database indexed according to the database model.

According to an aspect of some embodiments of the present invention there is provided a method for controlling a graphical user interface (GUI) to display search results according to search operators applied by a search server on a database, the method including: translating a search term received via a GUI to a search operator by: identifying in an e-commerce database model an attribute related to an e-commerce category that correspond to the received search term, the database model includes a value space of possible values of the identified attribute; and determining based on distribution of values in the value space the suitable type of search operator for translation of the search term; extracting search results by applying the determined search operator on a database indexed according to the database model; and updating the GUI to display the search results along with indication of applied operators.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic flowchart illustrating a method for dynamic presentation of search results, according to some embodiments of the present invention;

FIG. 2 is a schematic illustration of a system for dynamic presentation of search results, according to some embodiments of the present invention;

FIG. 3 is a schematic flowchart illustrating a method for interpretation of a search term as a filtering or sorting parameter according to some embodiments of the present invention; and

FIG. 4 is a schematic illustration of a portion of a dynamically changing graphical user interface (GUI), according to some embodiments of the present invention.

### DESCRIPTION OF SPECIFIC EMBODIMENTS OF THE INVENTION

Some embodiments of the present invention provide a system and method for translating search terms to search operators such as sorting and/or filtering search operators, usable by a search server in order to extract search result from a target database.

The method and system according to some embodiments of the present invention enable analysis of a complex search query and interpret the meaning of the search query according to a database model. The database model according to some embodiments of the present invention includes database model elements such as categories, attributes related to the categories and value spaces of the attributes, wherein a value space of an attribute includes all the possible values of an attribute according to the model. For example, the value space of the attribute “weight” of the category “laptop” may include values ranging from about 1 to about 3 kilograms. Based on analysis of the value space and/or of the distribution of values in the value space, the search server may use the corresponding attribute as a sorting or as a filtering parameter, and apply a corresponding filtering or sorting operator on the target database in order to obtain search results.

Therefore, some embodiments of the present invention provide a technical solution for increasing the quality of search results, the computational efficiency and the time efficiency of database searches, by automatically translating a complex query into a ranking algorithm relevant to the query's meaning, while also applying filters and sorting operators that are appropriate to the nature and nuances of the query. The system allows users to express themselves naturally (in speech, touch, text) and for this to be completely understood by the system.

The provided solution may apply to various user-facing permutations—such as standard textual search engines with textual input, speech to text systems, touch based system where touch is translated to text, Internet of Things (IOT) systems and/or dialogue systems.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

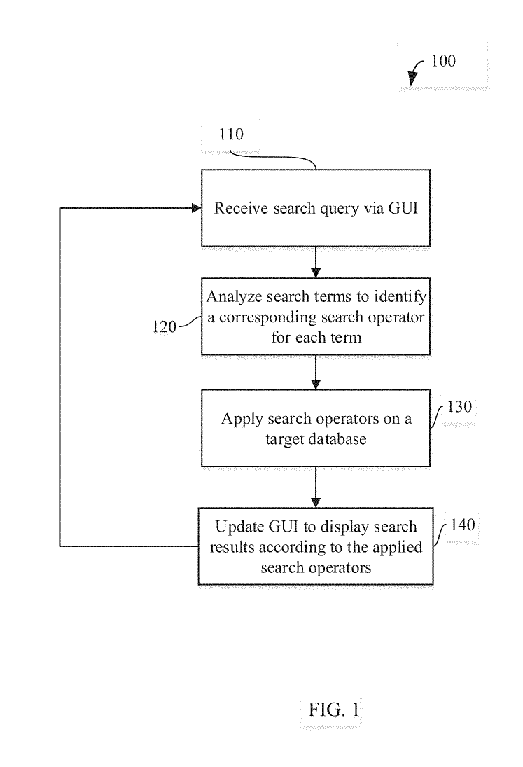

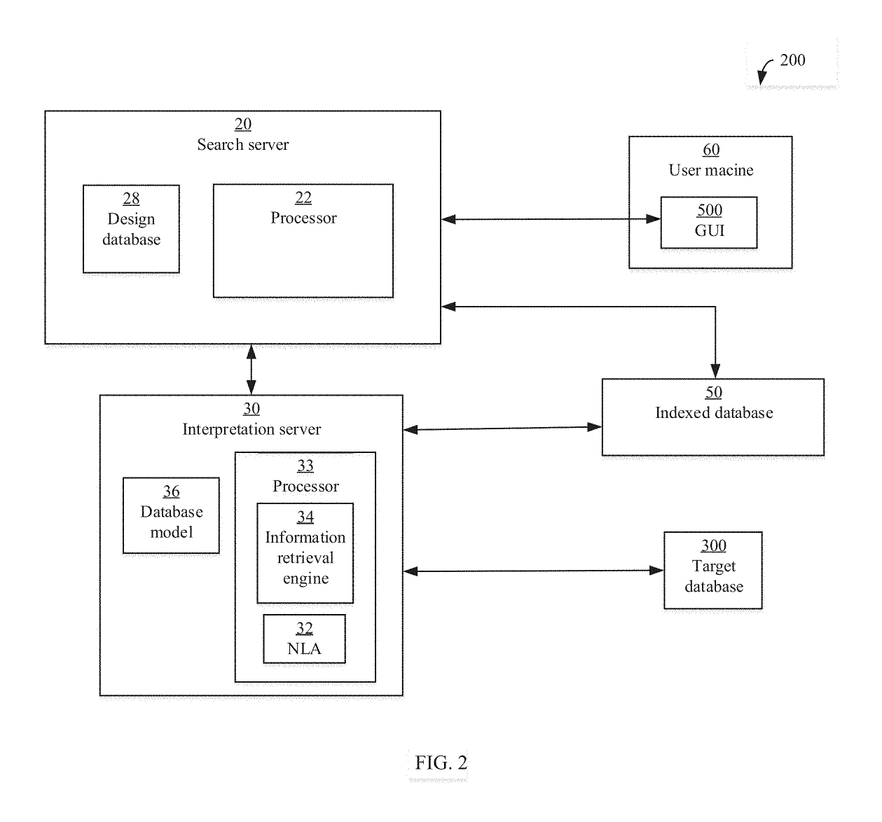

Reference is now made to FIG. 1, which is a schematic flowchart illustrating a method 100 for database search by translating search queries to search operators, according to some embodiments of the present invention. Further reference is now made to FIG. 2, which is a schematic illustration of a system 200 for database search by translating search queries to search operators, according to some embodiments of the present invention. System 200 includes a search server 20, and an interpretation server 30. Search server 20 may control a graphical user interface (GUI) 500. A search operator according to some embodiments of the present invention may include filtering, sorting, ranking, thresholds and/or any other search functions applied by search server 20 for obtaining search results from a searched database, by filtering, sorting, ranking, thresholds and/or any other respective operation.

GUI 500 may be provided to a user for performing a search in a target data source 300. Target data source 300 may be an e-commerce catalogue, website or database of e-commerce items presented in websites, for example products presented for sale. Target data source 300 may include information about each item, such as its price and relevant technical specification details, as well as a category and/or sub-categories to which the item belongs.

As indicated in block 110, search server 20 may receive from a user machine 60 a search query, for example via GUI 500 executed on user machine 60. The search query may include, for example, text input and/or other search query data, such as an indication of a specific category and/or a target data source 300.

Some embodiments of the present invention provide a database model, stored in a repository 36 and/or monitored by interpretation server 30. The database model facilitates translation of search terms to relevant search operators for performing search in a modeled database 50, generated by adapting target data source 300 to the database model. Interpretation server 30 may create an indexed database 50 by indexing the data included in target searched data source 300 according to the database model. In indexed database 50, each item of the searched database belongs to certain categories and/or subcategories and has values of attributes related to these categories.

As indicated in block 120, interpretation server 30 may analyze each search terms to identify a corresponding search operator. For example, interpretation server 30 executes a Natural Language Analyzer (NLA) 32 and an information retrieval engine 34. NLA 32 may find in the database model possible interpretations of terms of the search query. A received search query may be interpreted according to the database model, so that a term included in the query is identified as a category, an attribute or a value of the database model, which may be translated to a filtering, sorting and/or any other suitable search operator. For example, a filtering operator may include a function used by search server 20 for filtering indexed database 50, i.e. to leave out items that are not in the corresponding category and/or not having the corresponding attribute and/or value, in order to obtain search results.

Accordingly, information retrieval engine 34 may obtain possible interpretations of the search query by NLA 32, and construct a modeled representation of the search query, i.e. representation of the search query by corresponding filtering and/or sorting parameters implemented in the database model, which may be used as filtering and/or sorting operators, respectively. An interpretation of the search query may include categories, attributes and/or values defined in the database model, which are identified as a coherent interpretation of the search query elements. Accordingly, search server 20 may obtain by interpretation server 30 a modeled interpretation of the search query, i.e. interpretation of the search query based on the database model. The interpretation of the search query may include, for example, a representation of the search query by search operators that filter and/or sort according to parameters of the database model, i.e. categories, attributes and/or values.

As described herein, NLA 32 may translate category, an attribute or a value of the database model into a search operator such as, for example, sorting, filtering, and/or ranking search operator. The decision of what search operator a query is translated to is made based on rules implemented in the data base model.

A database model according to some embodiments of the present invention includes a lexicon of terms that may be updated regularly. A term included in the lexicon may be located in the model as a category, attribute and/or value. For example, each product included in the database model may be identified by a category, and values of attributes related to this category. For example, a Canon 60D camera may be identified by its attribute values such as weight, price, external features and/or any other suitable attribute value.

By interpreting the search query, NLA 32 translates the search query into a structured modelled query represented by the model's categories, attributes and/or values that may be used for searching in database modelled according to the same model. Additionally, NLA 32 determines the actions search server 20 should take based on that interpretation, i.e. whether a term constitutes a sorting, filtering or ranking search operator. NLA 32 may also determine, based on rules implemented in the model, the operator's manner of operation such as by what features, values or expressions search server 20 should sort, filter or rank. And it also determines what signals to show alongside results, if needed.

Because the lexicon is dynamic and continuously populated and updated by new data, the interpretations given to queries and/or the corresponding determined search operators can change.

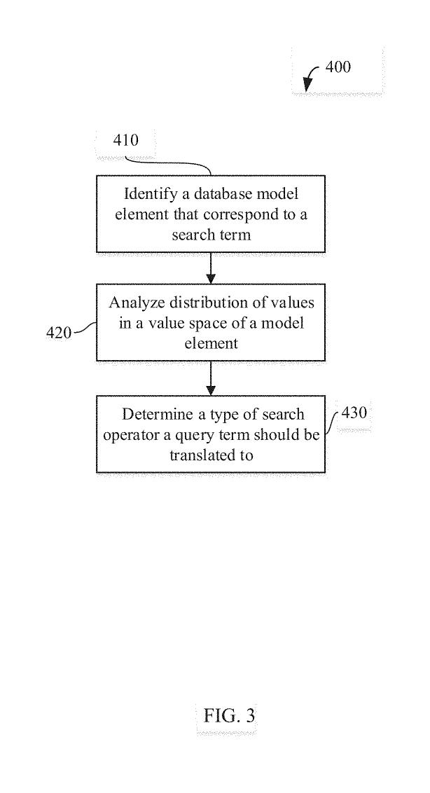

Reference is now made to FIG. 3, which is a schematic flowchart illustrating a method 400 for interpretation of a search term as a filtering or sorting parameter according to some embodiments of the present invention. As indicated in block 410, NLA 32 may identify a database model element, i.e. a category, attribute and/or value of an attribute that correspond to a search term, for example based on literal similarity of the term to a name of a category, attribute and/or value, and/or based on a rule embedded in the data base model. For example, the database model may include rules that identify a term as a value and/or value type and/or relate a term to a certain attribute, value and/or category. For example, the term “500 gigabyte” may be related by a rule to a hard drive capacity value.

For each attribute, the database model may include a corresponding value space of all possible values of the attribute according to the database model. As indicated in block 420, NLA 32 may analyze a distribution of values in the value space, which may be indicative of the corresponding type of search operator, i.e. a filtering, ranking or sorting operator.

For example, the lexicon included in the database model may include words and terms data that may be updated regularly, for example about e-commerce products. For example, the lexicon may include terms along with indication of their meaning, such as “blue”, “orange”—for example as color values, “Adidas”, “galaxy”, “s6”, “play satiation 3”, “the north face”—for example as brand name values, “operating system”, “internal memory”, “smartphone”, “decibel”, “radiation”—as categories and/or attributes, and the like.

In some embodiments, the lexicon is built from a pre-defined updatable product knowledge model. In particular, the model may include concepts (e.g. “computer”), attribute names (e.g., “operating system”) values or attributes (e.g., “Windows 10”) and adjectives of numeric attributes (“large memory”/“a lot of memory”) relevant to terms of the e-commerce domain. In some embodiments of the present invention, the lexicon terms may be associated with other terms as synonyms. For example, the term “north face” may be a synonym of “the north face”, “ms” may be a synonym of “Microsoft”, “memory” may be a synonym of “internal memory” and “ssd volume”, “ram” may be a synonym of “internal memory”, “win7” may be a synonym of “windows 7”, “os” may be a synonym of “operating system”, “db” may be a synonym of “decibel”, and the like.

In some embodiments of the present invention, once receiving a query, NLA 32 may produces a set of interpretations. For example, the query “silver phone” may be interpreted according to the database model as represented by the concept/category “cellular phone” and by the color attribute value “silver”. In case there is only a single interpretation in this case, NLA 32 may translate the term “silver” to a filtering operator, by which search server 20 may filter the cellular phone category and return a result list including only silver-colored phones. Other operators may be used for ranking of the results list, such as popularity, sales rank, historical user preferences, as the like. For example, a user may define preferred ranking parameters or search server 20 may identify ranking preferences based on a user's behavior and rank the results accordingly.

For example, the query “orange phone” may be interpreted according to the database model as represented by the concept/category “cellular phone” and by the color attribute value “orange” or alternatively the concept/category “cellular phone” and by the cellular operator attribute value “orange mobile”. NLA 32 may translate the term “orange” to two different filtering operators. Search server 20 may return a result list that include both orange-colored phones and phones that work with Orange mobile operator.

Similarly, in another example, the query “laptop 16 GB” may be translated to a filtering operator for filtering out from the search results all laptops with internal memory below 16 gigabytes, or for filtering out from the search results all laptops with solid state drive (SSD) volume below 16 gigabytes. The query “laptop large memory” may be translated to a sorting operator to sort search results according to internal memory size or SSD volume size.

In order to choose between to possible interpretations, NLA 32 may analyze the probability of each interpretation, for example the probability that a user that types “orange phone” refers to the color vs. the probably that a user that type “orange phone” refers to the orange mobile operator. The probabilities are estimated, for example, based on past user behavioral data. For example, whether users that typed the “orange phone” query chose from the search results an orange-colored phone or Orange operator mobile phone. For example, in case an interpretation has a probability of 80 percent, the top results will be of this interpretation and results of the second interpretation will be presented later in the list. A measure of boosting, i.e. bringing up in the results list, of a certain kind of search results may depend on the probably that a user that refers to a memory in the context of a laptop means internal memory vs. the probability that he means SSD volume. This probably may be extracted from user behavioral data and/or calculated based on the importance of the internal memory attribute vs. the SSD one, for example according to definitions implemented in the model.

For example, the query “smartphone with best camera” may be interpreted according to the database model as represented by the attribute “camera quality”, the values of which may be calculated, for example, based on other attributes and/or based on model-implemented definitions. NLA 32 may translate the term “best camera” to a sorting operator for sorting the cameras by values of the “camera quality” attribute.

As indicated in block 430, NLA 32 may determine a type of search operator a query term should be translated to. For example, a query term may be interpreted as a Boolean attribute such as “waterproof”, “with camera” (for example a smartphone attribute), “for students” (for example a laptop attribute) a certain color, a certain operating system or any other suitable Boolean attribute. Such attributes may be translated into corresponding filtering operators, used by search server 20 for filtering search results to include only items with the respective attributes. In other cases, a query term may be interpreted as a multi-value attribute such as a physical dimension attribute, memory size, weight, battery life score, camera score, price, release date, general device score, popularity or any other suitable multi-value attribute. Such attributes may be translated into corresponding sorting operators, used by search server 20 for sorting search results according to attribute values.

As indicated in block 130, once the search operators are identified, search server 20 may apply the search operators on indexed database 50 to obtain search results. For example, search server 20 may receive the query “light laptop”. NLA 32 may associate, based on definitions embedded in the database model, the term “light” with small values of the attribute “weight” and interpret the query by matching to the query the category “Laptop” of the database model, which has the attribute “weight”. Based on this interpretation of NLA 32, search server 20 may apply a laptop filtering operator to filter the items in indexed database 50 according to the category “laptop” and apply a weight sorting operator to rank the results according to the weight value of each item in this category, wherein items with smaller weight values receive higher ranking, according to the interpretation of the term “light” by NLA 32.

In some embodiments of the present invention, a search term may be interpreted by NLA 32 as a filtering operator for filtering out search results with values that cross a threshold that may be indicated in the query or a predefined threshold embedded in the database model. For example, the term “light” may be interpreted by NLA 32 as a filtering operator for filtering out search results with weight values above a predefined threshold. For example, the term “good ram” may be interpreted as a filtering operator for filtering out search results with internal memory values below a predefined threshold. Based on the interpretation, search server 20 may apply a corresponding threshold filtering operator to filter the “laptop” category items according to the predefined threshold and/or a sorting operator to rank the results according to the parameter values such as weight or internal memory values.

Accordingly, by applying the search operators on indexed database 50, search server 20 may obtain as search results modeled representations of items stored in database 50, along with ranking and/or query-specific information about the listed items. Search server 20 may obtain, along with the search results, information about attributes and/or values of the items and/or the resulting ranking, according to attributes and/or values indicated in the interpreted search query. For example, in response to the query “light laptop”, search server 20 may obtain a list of laptop items included in database 50, along with their respective weight values and ranked according to the respective weight values.

As indicated in block 140, search server 20 may update GUI 500 to display search results according to the applied search operators. At least one hardware processor 22 may analyze the search results and produce a design for GUI 500 accordingly. The analysis may include, for example, extraction of ranking and/or query-related information from the results, identification of the filtering and sorting operators that were applied and/or extraction of statistical information, such as a quantity and/or percentage of items filtered out and/or left in the results list by each of the applied filters, for example relative to the entire target database and/or to a specific category. Accordingly, in some embodiments, GUI 500 is designed to display search results along with information about each of the items that is particularly relevant to the search query. Search server 20 may update GUI 500 according to the produced design.

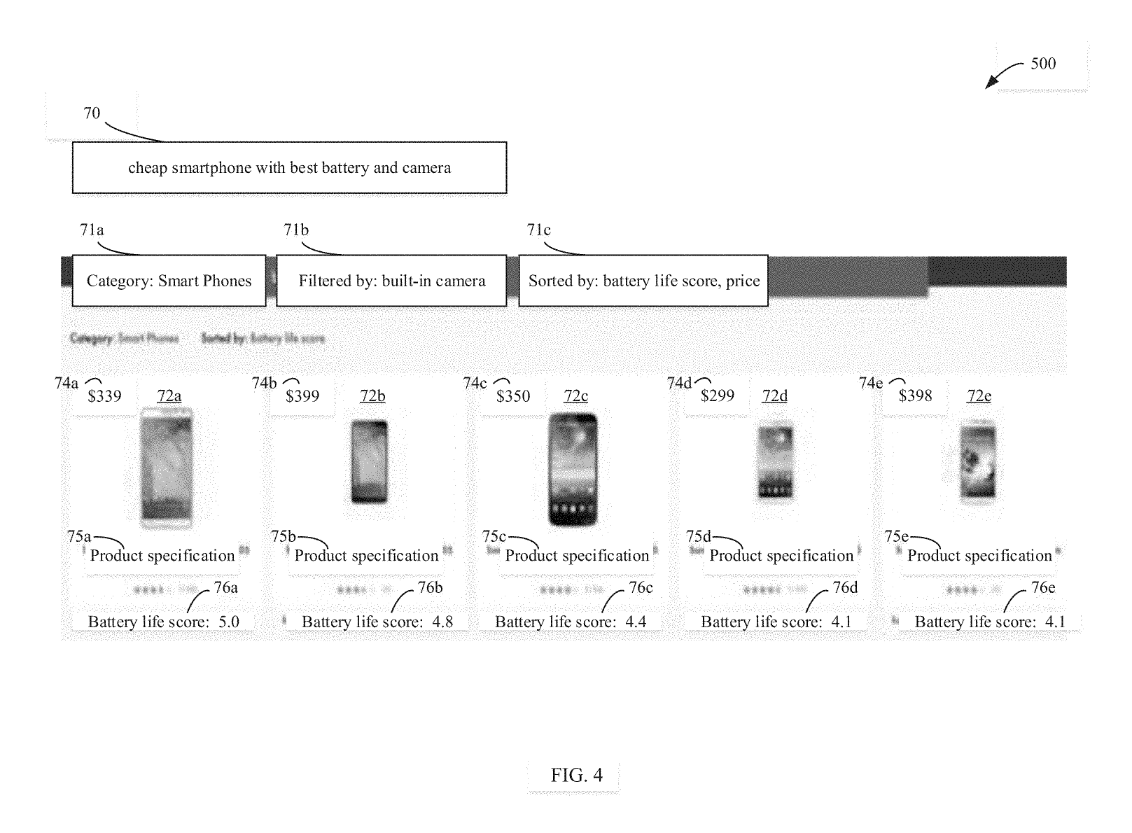

Reference is now made to FIG. 4, which is a schematic illustration of a portion of a dynamically changing GUI 500, according to some embodiments of the present invention. GUI 500 may include a query field 70, showing a query entered by a user. GUI 500 may include a category field 71a, a filtering parameter field 71b, a sorting parameter field and search result items 72a-72e, for example each along with an image of the item. GUI 500 may be updated upon any change in the search query and/or every pre-determined period of time. This way, it may be shown to a user how an addition, subtraction, or change of a term in the search query impacts the order and/or amount of items available in the database that suits the search query, and/or the information provided.

For example, in response to the search query “cheap smartphone with best battery and camera”, GUI 500 presents search result items 72a-72e, e.g. smart-phone items extracted from database 50. As described herein, GUI 500 is designed to display items 72a-72e along with accompanying information about each of the items that is particularly relevant to the search query, e.g. the respective prices 74a-74e and/or battery life scores 76a-76e of items 72a-72e. For example, NLA 32 may identify that “smart phone” is a category in which search server 20 should perform the search. The identified category may be indicated in category field 71a. For example, NLA 32 may compare the query terms to names of categories included in the database model and find in the database model a category with literal similarity to the term “smartphone”, i.e. the category “smart phone”.

As described in detail above, NLA 32 may translate terms identified as Boolean attributes to filtering operators, to filter search results according to corresponding filtering parameters. For example, NLA 32 may translate the term “with camera” to a filtering operator “built-in camera” based on a corresponding filtering parameter, to filter out from the search results smart phones with no built-in camera. The determined filtering parameters identified in the search query may be indicated in filtering parameter field 71b.

As described in detail above, NLA 32 may translate terms identified as multi-value attributes to sorting operators, to sort search results according to corresponding filtering parameters. For example, NLA 32 may translate the terms “cheap” and/or “best battery” to respective sorting operators that sort the search results according to the database model sorting parameters “price” and “battery life score”, respectively. NLA 32 may interpret, for example based on a rule embedded in the database model, the term “cheap” as a sorting operator that provides higher ranking to items with smaller prices. Accordingly, search server 20 may instruct to display in GUI 500 items with smaller prices first. NLA 32 may interpret, for example based on a rule embedded in the database model, the term “best battery” as a sorting operator that provides higher ranking to items with longer battery life. Accordingly, search server 20 may instruct to display in GUI 500 items with longer battery life first. The determined sorting parameters identified in the search query may be indicated in filtering parameter field 71c.

In some embodiments, the design of GUI 500 may include showing the accompanying information in the vicinity of the search result, for example when the search result is selected and/or indicated by a mouse, keyboard, touch and/or any other selection and/or indication method. The accompanying information may also include respective product specifications 75a-75e other data as preconfigured in the GUI design, for example name, manufacturer and/or model, of the item, and/or additional specification details of the specific product.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for translating a search query to search operators usable by a search server to extract search results from a database, the system comprising:
a memory storing a code; and
at least one hardware processor coupled to the memory for executing the code, the code comprising:
instructions for identifying in a database model an attribute related to a database category that corresponds to a search term received via a search user interface, the database model includes a value space of possible values of the identified attribute;
instructions for translating the search term to a search operator by analyzing distribution of values in the value space of the identified attribute and determining based on the analyzed distribution the whether to translate the search term to filtering or sorting search operator; and
instructions for extracting search results by applying the determined search operator on a database indexed according to the database model.

2. The system of claim 1, wherein the code comprises instructions for creating the indexed database by indexing data included in a target data source according to the database model, wherein each item in the indexed database belongs to a database category and has at least one related attribute value.

3. The system of claim 1, wherein identifying a corresponding attribute is performed by identifying literal similarity between the search term and the name of the attribute.

4. The system of claim 1, wherein identifying a corresponding attribute is performed according to a rule embedded in the database model that relates a term to a certain attribute.

5. The system of claim 1, wherein the code comprises instructions for determining if the type of operator is a sorting operator or filtering operator.

6. The system of claim 1, wherein the type of operator is determined according to identification of the attribute as a Boolean or multi-value attribute.

7. The system of claim 1, wherein the code comprises instructions for translating a query term to a threshold operator for filtering search results that cross a threshold determined by interpreting the term as a threshold according to the database model.

8. The system of claim 1, wherein the code comprises instructions for translating a query term to a sorting operator and for determining a direction of the sorting by interpreting a term as a ranking parameter according to the database model.

9. A system for controlling a graphical user interface (GUI) to display search results according to search operators applied by a search server on a database, the system comprising:
a memory storing a code; and
at least one hardware processor coupled to the memory for executing the code, the code comprising:
instructions for translating a search term received via a GUI to a search operator by:
identifying in an e-commerce database model an attribute related to an e-commerce category that correspond to the received search term, the database model includes a value space of possible values of the identified attribute; and
determining based on distribution of values in the value space the suitable type of search operator for translation of the search term;
instructions for extracting search results by applying the determined search operator on a database indexed according to the database model; and
instructions for updating the GUI to display the search results along with indication of applied operators.

10. The system of claim 9, wherein updating the GUI comprises updating at least one of presented search results, an order of the search results and query-related information presented in the vicinity of the search results.

11. The system of claim 9, wherein the code comprises instructions for extracting along with the search results query-specific information about the search results according to interpretation of the query terms by the database model, and for updating the GUI to display query-related information in the vicinity of the search results.

12. A method for translating a search query to search operators usable by a search server to extract search results from a database, the method comprising:
identifying in a database model an attribute related to a database category that corresponds to a search term received via a search user interface, the database model includes a value space of possible values of the identified attribute;
translating the search term to a search operator by analyzing distribution of values in the value space of the identified attribute and determining based on the analyzed distribution whether to translate the search term to filtering or sorting search operator; and
extracting search results by applying the determined search operator on a database indexed according to the database model.

13. A method for controlling a graphical user interface (GUI) to display search results according to search operators applied by a search server on a database, the method comprising:
translating a search term received via a GUI to a search operator by:
identifying in an e-commerce database model an attribute related to an e-commerce category that correspond to the received search term, the database model includes a value space of possible values of the identified attribute; and
determining based on distribution of values in the value space the suitable type of search operator for translation of the search term;
extracting search results by applying the determined search operator on a database indexed according to the database model; and
updating the GUI to display the search results along with indication of applied operators.
